(19) United States
(12) Patent Application Publication
(10) Pub. No.: US 2006/0060441 A1
(43) Pub. Date: Mar. 23, 2006

(54) Hybrid vehicle slip prevention apparatus

(76) Inventors: Moriharu Sakai, Kariya (JP); Takashi Watanabe, Nagoya (JP); Shoichi Masaki, Chiryu (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/530,050

(22) PCT Filed: Sep. 29, 2003
(86) PCT No.: PCT/JP03/12444

§ 371 Date: Apr. 4, 2005

(30) Foreign Application Priority Data
Oct. 8, 2002 (JP) 2002-295139

(51) Int. Cl. B60L 9/00

(52) U.S. Cl. 191/2

(57) ABSTRACT

A vehicle slip stop device which can always and reliably prevent slip of the vehicle. It includes a plurality of different types of slip stop means for increasing the frictional resistance relative to the road surface, i.e. first slip stop means 1 for scattering slip preventive material between the tires and the road surface, and a second slip means 4 including a braking plate 3 adapted to be pressed against the road surface by a cylinder 2. A controller 6 determines the road surface condition based on the image of the road surface captured by a TV camera 5, and according to the thus detected road surface condition, selects and actuates either the first slip stop means 1 or the second slip stop means 4. With this arrangement, even if one of the means 1 and 4 fails, the other can be actuated as a backup. Also, it is possible to select the most suitable one according to the road surface condition.

### TECHNICAL FIELD

This invention relates to a vehicle slip stop device for avoiding collision and slippage of a vehicle.

### BACKGROUND ART

When a vehicle is traveling on a frozen road, a wet paved road, or a dry paved road on which sand is present, the ability of their tires to grip such road surfaces tends to be low, so that the tires will easily slip. Thus, on such road surfaces, even if a conventional braking system is actuated to brake the wheels at full power, the vehicle will travel a very long distance until it comes to a complete stop. This increases the chance of the vehicle crashing into an obstacle, irrespective of its traveling speed.

On such a low-friction road surface, the individual wheels typically slip to different degrees, thus destabilizing the behavior of the vehicle. In the worst case, the vehicle may steer out of the intended lane, and get into an accident. Today, various devices are available that ensure stable travel of vehicles, such as an anti-lock brake system (ABS), which detects the degrees of slip of the individual wheels, and individually controls the braking forces to the respective wheels, and a vehicle stability control (VSC) system, which detects the steering tendency of the vehicle based on information supplied from a yaw rate sensor and a lateral acceleration sensor and controls the engine output and the braking forces to the individual wheels. In order for these devices to sufficiently reveal their intended functions, however, it is essential that there remain at least some tire grips.

In order to prevent vehicle accidents such as crashes on low-friction road surfaces, it has been proposed to mount on a vehicle, besides a conventional brake system, a slip stop means for preventing slipping of the vehicle by increasing the frictional resistance of the vehicle relative to the road surface. Such slip stop means include one which sprays a slip preventive material such as sand or grains of ice between the individual tires and the road surface (as disclosed in JP patent publications 4-38204, 7-309101 and 8-25905), one which applies a liquid adhesive on the tire surfaces and then sprays a slip preventive material on the tires to stick it on the tire surfaces (JP patent publication 63-2706), one which blows cold air against the tires to prevent the tires from thawing the frozen road surface (JP patent publication 50-100703), one which includes a braking plate or a toothed braking ring which is adapted to be pressed against the road surface (JP patent publications 49-2228, 54-122528, 8-40222 and 8-156760), and one including a gas bag which is inflatable so as to protrude outwardly and be pressed against the road surface (JP patent publication 6-286586).

### DISCLOSURE OF THE INVENTION

Only one such conventional slip stop means is mounted on a vehicle. Thus, if it fails, or if the expendable material such as slip preventive material or liquid adhesive runs out and the driver does not know this fact, it will be impossible to prevent slippage of the vehicle.

Some of the above-described slip stop means cannot effectively prevent slippage of the vehicle according to the road surface condition. For example, a slip stop means of the type that scatters a slip stop material such as sand can prevent slippage on a frozen road surface, but on a dry paved road, it will promote, rather than prevent, slippage of wheels. But this type of slip stop means has its own advantage in that it can be easily returned to its original position or state and can be repeatedly actuated.

On the other hand, a slip stop means of the type including the braking plate or the like adapted to be pressed against the road surface works effectively practically on any road surface, but has a problem in that it is troublesome to return it to its original state after it has been actuated.

An object of the present invention is to provide a slip stop device which can reliably prevent slippage of a vehicle on a road surface of any condition.

According to the invention, there is provided a hybrid vehicle slip stop device comprising a plurality of different types of slip stop means for preventing slip of the vehicle by increasing the frictional resistance relative to a road surface on which the vehicle is traveling.

By providing a plurality of slip stop means of different types, even if one of them fails or slip preventive material runs out in one of the slip stop means, the other slip stop means can be actuated as a backup. Slippage of the vehicle can thus be always prevented reliably.

In the simplest arrangement, one of the plurality of different types of slip stop means is selected and actuated when a selection switch is depressed by the driver. Otherwise, such selection may be made automatically by a controller. In either case, priority of actuation may be set. If the selection is made automatically by the controller, the controller may be programmed to continuously check if the respective slip stop means are working normally and monitor the remaining amount of the expendable material so as to take into consideration the results of checking and monitoring in selecting and actuating one of the slip stop means.

The vehicle slip stop device may further comprise a road surface condition detecting means for detecting the road surface condition, wherein one of the plurality of different types of slip stop means is structured to be selected and actuated according to the road surface condition detected by the road surface condition detecting means. With this arrangement, it is possible to select and actuate the most suitable one of the slip stop means.

The road surface condition detecting means may be of the type in which the road surface condition is indirectly inferred from the relationship between the sum of the slip amounts of the individual wheels and the acceleration of the vehicle, or from the frequency response of the transmission characteristics from road surface disturbances to wheel speeds, as disclosed in JP patent publications 7-112659 and 2002-120709. Alternatively, the road surface condition may be directly detected from incident and reflected light beams, color tone, temperature, etc. which are obtained from a detector device using laser beams, a TV camera or a temperature sensor.

According to the present invention, even if one of the plurality of different types of slip stop means fails or slip preventive material runs out in one of these slip stop means, the other slip stop means can be actuated as a backup. Slippage of the vehicle can thus be always prevented reliably.

With the arrangement in which the vehicle slip stop device further comprises a road surface condition detecting means for detecting the road surface condition, wherein one of the plurality of different types of slip stop means is structured to be selected and actuated according to the road surface condition detected by the road surface condition detecting means, it is possible to select and actuate the most suitable one of the slip stop means.

### BRIEF DESCRIPTION OF THE DRAWINGS

FIG. 1 is a schematic view of a vehicle on which a hybrid vehicle slip stop device of a first embodiment is mounted;

FIG. 2 is a schematic view of first slip stop means of FIG. 1; and

FIG. 3 is a flowchart of an algorithm for actuating the hybrid vehicle slip stop device of FIG. 1.

### BEST MODE FOR EMBODYING THE INVENTION

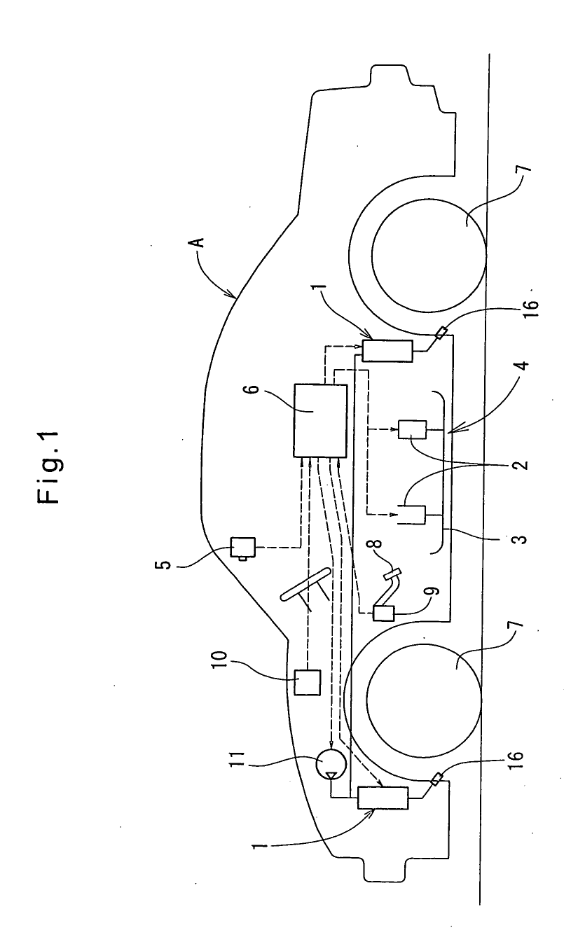

Now referring to FIGS. 1-3, the embodiment of the present invention is described. Referring first to FIG. 1, the hybrid vehicle slip stop device comprises first slip stop means 1 for blowing a slip preventive material into between the respective tires and the road surface to increase the frictional resistance between the tires and the road surface, a second slip stop means 4 including a braking plate 3 and a cylinder 2 for pressing the braking plate 3 against the road surface, thereby increasing the frictional resistance between the vehicle and the road surface, a TV camera 5 for capturing the image of the road surface in front of the vehicle A, and a controller 6 for selectively actuating the first slip stop means 1 and the second slip stop means 4.

Sensor outputs are entered into the controller 6 from a stepping force sensor 9 for sensing the stepping force F applied to a brake pedal 8 for actuating the brake system (not shown) for braking the respective wheels 7, and a deceleration sensor 10 for sensing the deceleration a of the vehicle A. The controller 6 compares the thus detected stepping force F and the thus detected deceleration α with thresholds F_{T} and α_{T}, respectively, to determine if it is necessary to actuate the slip stop device. If determined necessary, the controller 6 then determines which of the first and second slip stop means should be actuated based on the road surface condition determined from the image of the road surface captured by the TV camera 5.

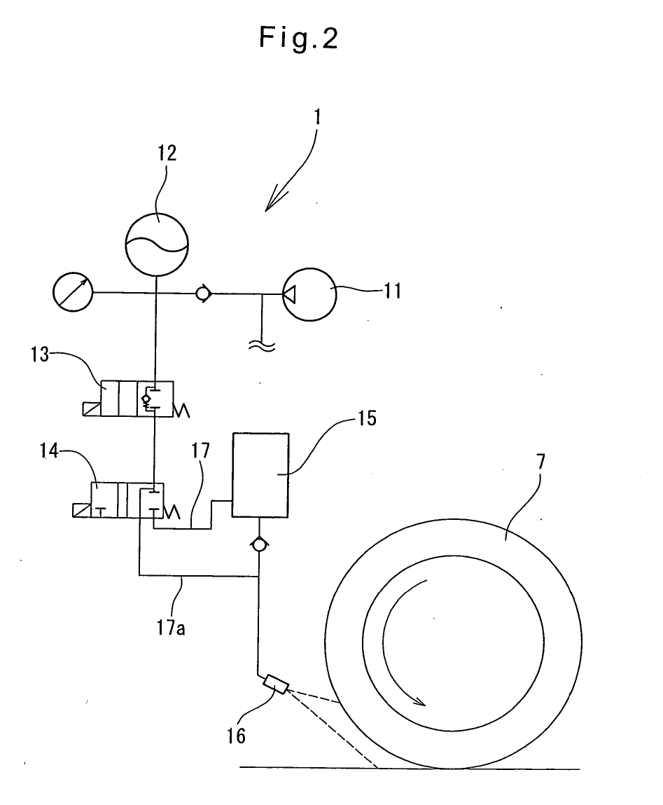

As shown in FIG. 2, the first slip stop means 1 each include an accumulator 12, a pump 11 for accumulating gas pressure in the accumulator 12, a container 15 for a slip stop material, and a nozzle 16 provided in front of a wheel 7. The controller 6 opens solenoid valves 13 and 14 to supply pressurized gas accumulated in the accumulator 12 into the container 15 through the solenoid valves 13 and 14 and a pipe 17, thereby blowing the slip stop material in the container 15 through a nozzle 16. While not shown, a plurality of such first slip stop means 1 are provided, each for one of the wheels 7.

A bypass pipe 17a extends between the solenoid valve 14 and the nozzle 16 while bypassing the pipe 17. As will be described later, if the controller 6 determines that it is necessary to take measures to stop slipping and further determines that the road surface is wet as a result of inspection of the image captured by the TV camera 5, it controls the solenoid valves 13, 14 so as to blow only gas through the nozzle 16 to blow away any water in depressions in the road immediately in front of the wheel 7. Gas is also supplied through the bypass pipe 17a in order to check if the nozzle 16 is clog-free and thus the first slip stop means 1 is functioning normally.

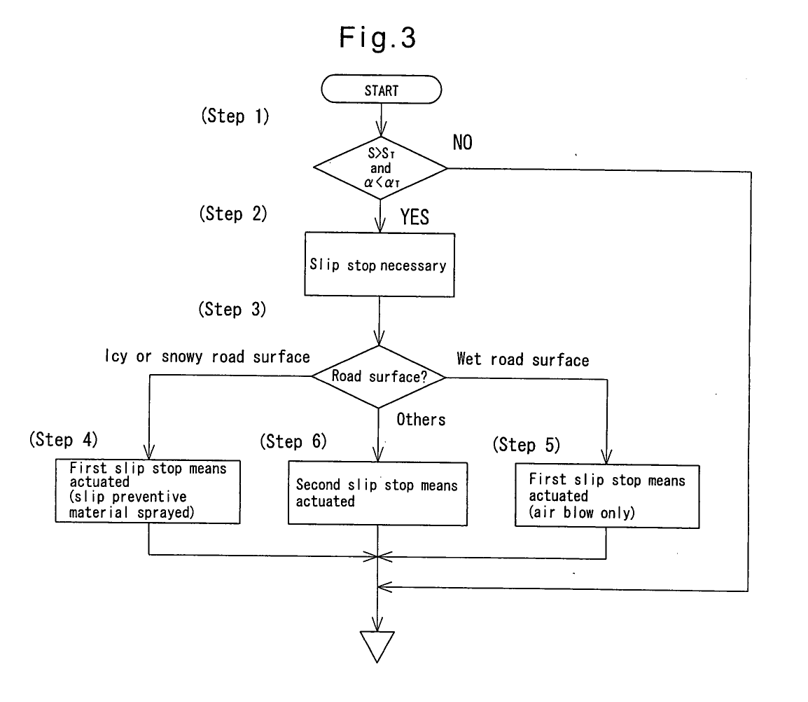

FIG. 3 is a flowchart showing the algorithm of the controller 6 for selectively actuating the hybrid vehicle slip stop device. First, the controller 6 compares the stepping force F and the deceleration α, which are being continuously fed from the stepping force sensor 9 and the deceleration sensor 10, with thresholds F_{T} and α_{T}, respectively (Step 1), and if the stepping force F is greater than the threshold F_{T} and the deceleration α is smaller than the threshold α_{T}, which means that the vehicle A is not being decelerated sufficiently in spite of the fact that the driver is depressing the brake pedal 8 hard because at least one of the wheels 7 is slipping, the controller 6 determines that it is necessary to actuate the slip stop device (Step 2).

The controller 6 then checks the condition of the road surface based on the image captured by the TV camera 5 (Step 3), and if the road surface is determined to be frozen or covered with snow, it will actuate the first slip stop means 1 to scatter the slip preventive material (Step 4). If the road surface is determined to be wet, the controller 6 actuates the first slip stop means 1 to blow only gas through the bypass pipe 17a of each means 1 (Step 5). If the road surface condition is otherwise, it actuates the second slip stop means 4 (Step 6).

The slip stop device of the above embodiment comprises a fist type of slip stop means for scattering slip stop material between the tires and the road surface, and a second type of slip stop means including a braking plate to be pressed against the road surface. But one or both of the first and second types of slip stop means may be replaced with other types. Of course, the slip stop device may comprise slip stop means of three or more different types.

Also, a selection switch may be provided so that the driver can select any of the slip stop means by operating the switch.

In the embodiment, the controller 6 determines the road surface condition based on the image of the road surface captured by the TV camera. But instead, the road surface condition may be determined based on information from a temperature sensor for measuring the road surface temperature, or a device for emitting laser beams onto the road surface and sensing the road surface condition from the distribution of the intensity of the laser beams reflected from the road surface. Alternatively, the road surface condition may be indirectly inferred from the relationship between the sum of the slip amounts of the individual wheels and the acceleration of the vehicle, or from the frequency response of the transmission characteristics from road surface disturbances to wheel speeds, as disclosed in JP patent publications 7-112659 and 2002-120709.

In the embodiment, the slip stop device is actuated when the brake pedal is depressed hard and at least one of the wheels begins to slip. But the slip stop device may also be actuated if at least one of the wheels slip when the vehicle starts, or if the wheels slip to different degrees, thereby destabilizing the vehicle.

1. A hybrid vehicle slip stop device comprising a plurality of different types of slip stop means for preventing slip of the vehicle by increasing the frictional resistance relative to a road surface on which the vehicle is traveling.

2. A hybrid vehicle slip stop device as claimed in claim 1 further comprising a road surface condition detecting means for detecting the road surface condition, wherein one of said plurality of different types of slip stop means is structured to be selected and actuated according to the road surface condition detected by said road surface condition detecting means.

3. A hybrid vehicle slip stop device as claimed in claim 1 wherein said plurality of different types of slip stop means are provided for the same one tire of the vehicle.
